(19) United States
(12) Patent Application Publication
(10) Pub. No.: US 2009/0153313 A1
(43) Pub. Date: Jun. 18, 2009

(54) Control and Warning Device for a Lane Keeping System in Particular

(76) Inventors: Volker Roelke, Leonberg (DE); Stephan Simon, Sibbesse (DE)

Correspondence Address: KENYON & KENYON LLP, ONE BROADWAY, NEW YORK, NY, 10004, US

(21) Appl. No.: 12/084,169

(22) PCT Filed: Sep. 6, 2006
(86) PCT No.: PCT/EP2006/066065

§ 371 Date: Jan. 5, 2009

(30) Foreign Application Priority Data
Oct. 31, 2005 (DE) 10 2005 052 029.4

(51) Int. Cl. B60Q 1/00

(52) U.S. Cl. 340/435

(57) ABSTRACT

A control and warning device and method, in particular for a lane keeping system of a motor vehicle, includes a control unit, a warning unit, an activation unit, and a display unit. The control unit has a data and/or signal connection to the lane keeping system, a warning unit, an activation unit and a display unit. The control unit receives a signal about the prevailing activation state and/or availability state from the lane keeping system.

### BACKGROUND INFORMATION

Lane keeping systems are already known in the related art. PCT International Patent Publication No. WO 2003/029908 describes a lane keeping system in which the road is observed using a camera and in which wheel sensors detect the driving forces on the wheels of the vehicle, one driving force of each wheel being influenced in a controlled manner on detection of a deviation of the vehicle from the lane.

PCT International Patent Publication No. WO 2005/047045 describes a lane keeping system in which the lane of the vehicle is detected. In addition, this publication describes an electric motor which is connected to the steering system and exerts a driving torque on the steering to support or counteract the driver in steering when necessary.

The disadvantage of these systems is that the lane keeping systems are unable to correctly recognize the lane at all points in time or under all road surface conditions because, e.g., in winter, the road surface markings are covered when there is a complete blanket of snow on the road and may no longer be reliably recognizable. Under such conditions, the driver of the vehicle would nevertheless be relying on the presumed functionality of the lane keeping system, which might result in a safety-critical situation, while the lane keeping system is to be used precisely for preventing such safety-critical situations.

### SUMMARY OF THE INVENTION

An object of the present invention is to provide a control and warning method and device using which the disadvantages of the related art are overcome and safety-critical situations are avoided.

According to the present invention, the control and warning device according to the present invention, in particular for a lane keeping system of a motor vehicle, has a control unit, a warning unit, an activation unit, and a display unit, the control unit having a data and/or signal connection to the lane keeping system, the warning unit, the activation unit and the display unit, and the control unit receiving a signal from the lane keeping system indicating the prevailing activation state and/or availability state.

It is particularly advantageous that the control unit activates this lane keeping system on the basis of a signal of the activation unit in the activatable state of the lane keeping system. This has the advantage according to the present invention that the lane keeping system is activated only when initiated by the driver in a targeted manner. Unintentional situations therefore do not occur because the driver is accustomed to the lane keeping system being activated automatically in the usual manner but not being available in specific situations.

In addition, it may be particularly expedient if the control unit delivers a warning signal through the warning unit and/or outputs it for display by the display unit based on a signal from the activation unit when the lane keeping system is not activatable. This draws the driver's attention to the fact that, despite the driver's intent, the lane keeping system will not be available to support the driver's driving and/or steering activity after an intervention measure by the lane keeping system.

According to the present invention, it is advantageous if the display unit displays the activation state and/or the availability and/or the activatability state of the lane keeping system. The driver is therefore able to estimate at any point in time the possibility or impossibility of activation of the lane keeping system, so that when activation is desired, the nonavailability of the lane keeping system is immediately discernible and the driver is not surprised by its nonavailability.

In addition, it is expedient if the warning unit outputs a warning signal and/or the display unit outputs a display when the lane keeping system switches from the activated state to the inactive and inactivatable state. A warning is likewise triggered in this way, thereby avoiding safety-critical situations.

It is particularly advantageous if the display unit includes means for visual and/or acoustic display and/or if the warning unit includes means of visual and/or acoustic and/or haptic warning and/or if the activation unit includes means for manual and/or acoustic activation of the lane keeping system.

An object according to the present invention is also achieved by a control and warning method according to the present invention, in particular in cooperation with a lane keeping system, a control and warning device being used with a control unit, a warning unit, an activation unit and a display unit, the control unit being in data and/or signal connection with a lane keeping system, the warning unit, an activation unit and a display unit and the control unit receiving from the lane keeping system a signal regarding the prevailing activation state and/or availability state.

It is appropriate here if the control unit outputs a warning signal for warning through the warning unit and/or for display through the display unit on the basis of a signal of the activation unit in the inactivatable state of the lane keeping system. It is likewise expedient if the display unit displays the activation state and/or the availability and/or the activatability state of the lane keeping system. It is also advantageous if the warning unit outputs a warning signal and/or the display unit outputs a display when the lane keeping system in the activated state switches to the inactive and inactivatable state. Each of these measures of the method according to the present invention ensure that safety-critical situations for the driver are avoided if the driver is informed and warned about the state of the system at all times.

### BRIEF DESCRIPTION OF THE DRAWING

FIG. 1 shows a block diagram for schematic representation of a device according to the present invention.

### DETAILED DESCRIPTION

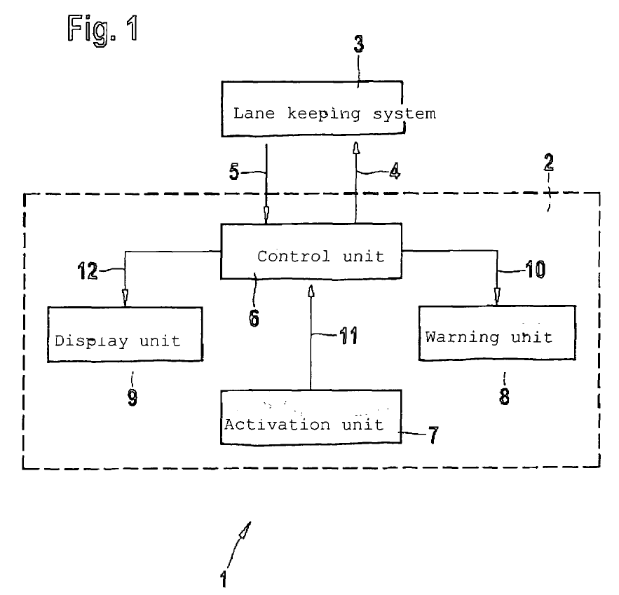

In a block diagram 1, FIG. 1 schematically shows the arrangement of a device 2 for controlling a lane keeping system 3 and for warning or informing the driver of a motor vehicle. Device 2 is in signal communication and/or data communication with lane keeping system 3, as indicated by arrows 4 and 5.

Lane keeping system 3 includes in a known way means for recognizing the lane or the road and the position of the vehicle therein, e.g., a camera or other optical sensors, for example. In addition, lane keeping system 3 includes a control unit that is able to determine the position of the vehicle within the lane on the basis of the available data and triggers a possible control and/or regulating intervention measure during a transverse movement of the vehicle with respect to the lane and the operating state data. This allows the vehicle to be steered automatically or the driver's steering activity to be supported or corrected.

Important to the present invention is the ability of lane keeping system 3 to generate or transmit a signal characterizing the activation state of lane keeping system 3 itself. On the basis of this signal, the lane keeping system signals whether or not it is activatable in the prevailing state. This signal 5 is relayed to a control unit, device 2 according to the present invention preferably having this control unit 6, which is capable of receiving data and/or signals from lane keeping system 3 according to arrow 5. In addition, control unit 6 is able to output data or signals to lane keeping system 3 according to arrow 4. Control unit 6 may be an independent control unit or it may be integrated into a control unit, e.g., that of lane keeping system 3. Control unit 6 may thus also be implemented on a joint computer platform together with the control unit of the lane keeping system.

According to arrow 11, control unit 6 has a data and/or signal connection to an activation unit 7. Activation unit 7 is or includes an activation element, which is manually operable by the driver of the vehicle, for example. Accordingly, the activation unit may be implemented as a button or a switch, e.g., a push button, which is operable by hand or foot. This operating element may be a switch element that is integrated into the steering of the vehicle, for example, and generates or transmits a signal when touched or released. However, activation unit 7 may also be designed differently, e.g., having a microphone, in which case the activation element responds to acoustic signals. It may be advantageous in particular if the activation unit includes a voice processing unit so that voice signals may also be used for activation.

In addition, the device includes a warning unit 8 for warning or informing the driver. Warning unit 8 has a data and/or signal connection to control unit 6 according to arrow 10. Warning unit 8 outputs a warning signal, for example, when the lane keeping system switches from the active state to the inactive state. This warning is therefore advantageous in particular according to the present invention because in the transition situation from the active state to the inactive state of the lane keeping system, the driver must again take over steering of the vehicle. Since this information constitutes important information for the safety of the occupants of the vehicle, it is particularly important for the driver to be informed about the change in the state of lane keeping system 3.

Warning unit 8 may be designed as a unit to output acoustic and/or visual signals. A visual display signal may be output for display in the cockpit of the vehicle, for example, or elsewhere. A visual signal may also be displayed in a so-called head-up display within the field of vision of the driver. With regard to an acoustic signal, output of warning tones or voice output is also possible. In addition, there may be a haptic warning. An embodiment of the warning unit according to the present invention may cause a controlled vibration of the driver's seat and/or the steering wheel to alert the driver to the change in state of lane keeping system 3.

In addition, device 2 according to the present invention includes a display unit 9, which has a data and/or signal connection to control unit 6 according to arrow 12. Display unit 9 is used for displaying the activation possibility and/or activation state of lane keeping system 3. Display unit 9 may advantageously display three activation states of the lane keeping system. It is possible to differentiate at least the following states:
lane keeping system available, not activated
lane keeping system activated
lane keeping system not available, not activatable
   and they may be displayed accordingly. According to the advantageous embodiments, it is also possible for only one or two of these states to be signaled.

For example, a visual display may be implemented as described below via a light, lamp or LED and/or via a display in the display unit of the cockpit and/or in the center console of the vehicle or elsewhere and/or via a display in the head-up display unit, etc.

For example, a yellow light may indicate the state “lane keeping system available, not activated,” a red light may indicate the state “lane keeping system not available, not activatable,” and a green light may indicate the state “lane keeping system activated.”

In the initial state at the start of driving or at the start of a trip, lane keeping system 3 is set at the “inactive” state. On the basis of available signals and/or data, lane keeping system 3 then checks on whether it is activatable and, if this is the case, lane keeping system 3 reports possible activation of the system to control unit 6. The state of activatability is displayed to the driver by display unit 9.

If the activatability state of lane keeping system 3 changes to “activatable,” the lane keeping system transmits this information, which is displayed by display unit 9, showing that the lane keeping system is available but has not been activated. If the lane keeping system is activatable, the driver may activate lane keeping system 3 via activation unit 7. Lane keeping system 3 then takes over the steering of the vehicle, but the steering that is performed may be overridden by the driver at any time, in which case then lane keeping system 3 advantageously automatically switches to the inactive state.

According to the present invention, it is expedient if, in the active state of lane keeping system 3, the system is no longer available, i.e., is not actively working, a warning signal or a warning is emitted via warning unit 8 and the driver is thus instructed to resume active steering.

In addition, according to the present invention, it may be advantageous that warning unit 8 emits a warning signal and/or display unit 9 outputs a display if the driver would like to activate lane keeping system 3 via activation unit 7 when lane keeping system 3 is in the inactive and inactivatable state.

According to an advantageous refinement of the present invention, a warning is issued via warning unit 8 and/or a display is issued via display unit 9 when the steering is not resumed again by the driver within a predefined period of time in the active state of lane keeping system 3. It is then possible to switch from the active state to the inactive state of lane keeping system 3 to force active steering on the part of the driver. Alternatively, lane keeping system 3 may also still remain in the active state even after the warning/display. Alternatively, lane keeping system 3 may also continue to remain active after a warning, in which case after a predefinable period of time, the system initiates a reduction in driving speed even to a standstill of the vehicle, if necessary.

According to the present invention, it may be advantageous if, through activation of lane keeping system 3 by the driver via activation unit 7, lane keeping system 3 is activated for only a limited period of time, so that through repeated activation after automatic deactivation, this achieves the result that the driver's attention continues to remain directed at driving the vehicle.

The present invention also includes a method for operating a device as described above.

1-13. (canceled)

14. A control and warning device for a lane keeping system of a motor vehicle, comprising:
a control unit in data and/or signal connection with the lane keeping system, the control unit receiving a signal from the lane keeping system regarding a prevailing activation state and/or availability state.

15. The device according to claim 14, wherein the control unit activates the lane keeping system on the basis of a signal of an activation unit which is in data and/or signal connection to the control unit in an activatable state of the lane keeping system.

16. The device according to claim 14, wherein, in an inactivatable state of the lane keeping system, the control unit outputs a warning signal through a warning unit and/or for display by a display unit based on a signal of an activation unit, wherein at least one of the activation unit, the warning unit and the display unit are in data and/or signal connection with the control unit.

17. The device according to claim 16, wherein the display unit displays the activation state and/or the availability or activatability state of the lane keeping system.

18. The device according to claim 16, wherein the warning unit outputs a warning signal and/or the display unit outputs a display when the lane keeping system switches in an activated state to an inactive, inactivatable state.

19. The device according to claim 16, wherein the warning unit outputs a warning signal and/or the display unit outputs a display when the lane keeping system in an activated state automatically switches to an inactive, activatable state.

20. The device according to claim 16, wherein the display unit includes means for visual and/or acoustic display.

21. The device according to claim 16, wherein warning unit includes means for visual and/or acoustic and/or haptic warning.

22. The device according to claim 16, wherein the activation unit includes means for manual and/or acoustic activation of the lane keeping system.

23. A method for controlling and warning, in cooperation with a lane keeping system, comprising:
using a control and warning device with a control unit, the control unit being in data and/or signal connection with the lane keeping system, the control unit receiving from the lane keeping system a signal indicating a prevailing activation state and/or availability state.

24. The method according to claim 23, wherein in an inactivatable state of the lane keeping system the control unit outputs a signal for a warning by a warning unit and/or for display by a display unit on the basis of a signal of an activation unit, which is in data and/or signal connection with the control unit.

25. The method according to claim 23, wherein a display unit, which is in data and/or signal connection with the control unit, displays the activation state and/or the availability or the activatability state of the lane keeping system.

26. The method according to claim 23, wherein a warning unit, which is in data and/or signal connection with the control unit, outputs a warning signal and/or a display unit outputs a display when the lane keeping system switches from an activated state to an inactive inactivatable state.
